(19) United States
(12) Patent Application Publication
(10) Pub. No.: US 2012/0206399 A1
(43) Pub. Date: Aug. 16, 2012

(54) Method and System for Processing Signals of Touch Panel

(75) Inventors: Chuen-Heng Wang, Taipei (TW); Chien-Hsien Wu, Taipei (TW)

(73) Assignee: Alcor Micro, Corp., Taipei (TW)

(21) Appl. No.: 13/071,197

(22) Filed: Mar. 24, 2011

(30) Foreign Application Priority Data
Feb. 10, 2011 (CN) 100104480

(51) Int. Cl. G06F 3/044

(52) U.S. Cl. 345/174

(57) ABSTRACT

A method and system for processing the signals of a touch panel are provided. Therein, the capacitive values of each sensor on the touch panel are successively taken during a period of time. Then, the average capacitive value of each sensor is calculated for computing estimated touch point coordinates. The distance between each two sets of such coordinates sensed respectively at two sensing time points is calculated. If a distance thus calculated is less than a predetermined distance, the two sets of estimated touch point coordinates corresponding to the distance are defined as valid touch point coordinates. If a series of estimated touch point coordinates are successively defined as valid touch point coordinates for a predetermined number of times, the touch point corresponding to each set of valid touch point coordinates in the series is defined as a valid touch point. Thus, the precision of touch point determination is enhanced.

### BACKGROUND OF THE INVENTION

1. Technical Field

The present invention relates to methods and systems for processing the signals of a touch panel. More particularly, the present invention relates to a method and a system for reducing the surge noise and stray capacitance noise of a touch panel control circuit and thereby preventing such noises from lowering the accuracy of touch point determination.

2. Description of Related Art

Driven by the increasingly popular concept of Natural User Interface (NUI), multi-touch interactive interface is now widely used in various personal mobile devices such as personal digital assistants (PDAs) and Apple's iPhone mobile phones. As for personal computers, the Windows 7 operating system also supports multi-touch operation on display devices having touch control functions. In a nutshell, the multi-touch technology has become a current trend in the related industry.

Nowadays, the mainstreams of commercially available touch panels can be generally categorized as resistive or capacitive. A resistive touch panel is virtually a piece of indium tin oxide (ITO) glass and an ITO film stacked together, wherein an applied force is required to bring the ITO glass and the ITO film into contact and hence electrical connection so that further calculation can be carried out to determine the location of the touch point. However, the resistive touch panel has some obvious drawbacks. First of all, the panel surface is very likely to be damaged by scratching, which translates into a short service life. Secondly, as the resistive touch panel is characterized by low light transmittance, the underlying LCD panel requires strong backlight and therefore results in increased power consumption. Moreover, the resistive touch panel has a relatively long response time, and input errors tend to occur if the user fails to control the applied force stably.

The capacitive touch panel, on the other hand, works on a different principle as briefly stated below. Before a capacitive touch panel is touched, all the points on the touch panel have the same electric potential. Once the touch panel is touched, a weak electric current is generated between the user's body and the touch panel, thereby creating a capacitive field, which is analyzed by sensors in order to determine the location of the touch point. When the user's finger moves along the touch panel, a touch path is defined accordingly.

The major drawback of the capacitive touch panel consists in its high sensitivity to the surroundings. Whenever the ambient temperature, moisture, or electrical field changes, the signals of a capacitive touch panel tend to shift or are subject to noise, both of which are detrimental to the sensing accuracy of the capacitive touch panel.

The projected capacitive touch panel is an improvement over the capacitive touch panel and features multi-touch control; in other words, the touch panel can sense more than one touch point at the same time. Nevertheless, a touch panel which supports multi-touch control is susceptible to periodic surge noise, and the noise will decrease the accuracy of touch point determination.

FIG. 1 is a schematic diagram of a known touch panel control circuit capable of noise reduction (see U.S. Pat. No. 6,624,835 B2). As shown in FIG. 1, the conventional controller circuit 10 in a touch panel is connected to a trigger circuit 11 so as to obtain signals which are synchronous with the signals of the screen 12, with a view to detecting period surge noise caused by the screen 12. To counteract the surge noise of the screen 12, the controller circuit 10 must acquire signals which are synchronous with those of the screen 12, and the controller circuit 10 must not capture the sensing results of the sensors 13 until the trigger circuit 11 sends out the signals.

The controller circuit 10 takes average of the touch panel sensing results detected at two different time points and uses the average thus obtained as a valid sensing result for determining the touch point. However, as the touch points corresponding to two consecutive detection time points must be at different locations when the user's finger moves along the touch panel, the averaging process will involve the sensing results of both touch points and non-touch points and therefore compromise the accuracy of touch point determination.

### BRIEF SUMMARY OF THE INVENTION

It is an object of the present invention to provide a method and system for processing the signals of a touch panel, wherein the method and system are designed to reduce the surge noise and stray capacitance noise of a touch panel controller circuit and thereby prevent such noises from lowering the accuracy in determining the touch points on the touch panel.

It is another object of the present invention to provide a method and system for processing the signals of a touch panel, wherein in order to effectively filter out surge noise, an oversampling process is performed on the sensing results of each sensor of the touch panel, such as by taking four or eight samples of the sensing results of each sensor, and then two or four of the median sensing results of each sensor are averaged to determine the valid sensing result of each sensor.

It is yet another object of the present invention to provide a method and system for processing the signals of a touch panel, wherein a touch point is determined as valid or otherwise according to a predetermined touch point distance and a predetermined number of valid measurements so as to increase the accuracy of touch point determination.

To achieve the above and other objects, the present invention provides a method for processing the signals of a touch panel having a plurality of sensors, wherein the method includes the steps of: (a) taking the capacitive values of each sensor of the touch panel successively during a period of time; (b) calculating the average capacitive value of each sensor for the period of time, wherein the average capacitive value is calculated by removing at least one relatively large capacitive value and at least one relatively small capacitive value from the capacitive values taken of each sensor and then taking average of the remaining capacitive values of each sensor; (c) reading the average capacitive value of each sensor so as to calculate and generate at least one set of estimated touch point coordinates; (d) repeating steps (a) to (c) so as to obtain at least one set of estimated touch point coordinates at each of two consecutive sensing time points, followed by calculating the distance between each two sets of estimated touch point coordinates obtained respectively at the two sensing time points; (e) determining whether each distance is less than a predetermined distance, wherein if one certain distance is greater than the predetermined distance, the two sets of estimated touch point coordinates corresponding to the distance are defined as invalid touch point coordinates, and wherein if one certain distance is less than the predetermined distance, the two sets of estimated touch point coordinates corresponding to the distance are defined as valid touch point coordinates; and (f) repeating step (e), wherein if a series of estimated touch point coordinates are successively defined as valid touch point coordinates for a predetermined number of times, the touch point corresponding to each set of valid touch point coordinates in the series is defined as a valid touch point.

To achieve the above and other objects, the present invention also provides a system for processing the signals of a touch panel having a plurality of sensors, wherein the system includes: a sampling module for taking the capacitive values of each sensor of the touch panel successively during a period of time; a processing module for calculating the average capacitive value of each sensor for the period of time, wherein the average capacitive value is calculated by removing at least one relatively large capacitive value and at least one relatively small capacitive value from the capacitive values taken of each sensor and then taking average of the remaining capacitive values of each sensor; a conversion module for reading the average capacitive value of each sensor and, by calculation, generating at least one set of estimated touch point coordinates; a calculation module for reading at least one set of estimated touch point coordinates at each of two sensing time points and then calculating the distance between each two sets of estimated touch point coordinates read respectively at the two sensing time points; and a determination module for determining whether each distance is greater than a predetermined distance, wherein if one certain distance is greater than the predetermined distance, the two sets of estimated touch point coordinates corresponding to the distance are defined as invalid touch point coordinates; if one certain distance is less than the predetermined distance, the two sets of estimated touch point coordinates corresponding to the distance are defined as valid touch point coordinates; and if a series of estimated touch point coordinates are successively defined as valid touch point coordinates for a predetermined number of times, the touch point corresponding to each set of valid touch point coordinates in the series is defined as a valid touch point.

Implementation of the present invention at least involves the following inventive steps:

1. With the touch panel control circuit being configured on the touch panel, there is no need to detect information of screen noise.

2. Noise can be effectively filtered out to increase the accuracy of touch point determination.

3. Inaccurate sensing results attributable to environmental effects on the touch panel can be minimized to increase the precision of touch point determination.

The features and advantages of the present invention are detailed hereinafter with reference to the preferred embodiments. The detailed description is intended to enable a person skilled in the art to gain insight into the technical contents disclosed herein and implement the present invention accordingly. A person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

FIG. 1 schematically shows a conventional touch panel control circuit capable of noise reduction;

FIG. 2 schematically shows the structure of a touch panel control system to which the present invention is applicable;

FIG. 3 schematically shows a system for processing the signals of a touch panel according to an embodiment of the present invention;

FIG. 4 is a flowchart of a method for processing the signals of a touch panel according to an embodiment of the present invention;

FIG. 5 schematically shows a touch panel to which the system depicted in FIG. 3 is applicable;

FIG. 6A schematically shows a comparison region according to an embodiment of the present invention;

FIG. 6B schematically shows how the location of a gravity center is calculated according to an embodiment of the present invention;

FIG. 7 schematically shows how valid touch points are determined by the system depicted in FIG. 3;

FIG. 8A shows how signal-to-noise ratio is improved by incorporating a sampling module and a processing module according to an embodiment of the present invention;

FIG. 8B shows a comparison of error rates before and after the incorporation of a calculation module and a determination module according to an embodiment of the present invention to filter out surge noise; and

FIG. 8C shows a comparison of error rates before and after the incorporation of a calculation module and a determination module according to an embodiment of the present invention to filter out stray capacitance noise.

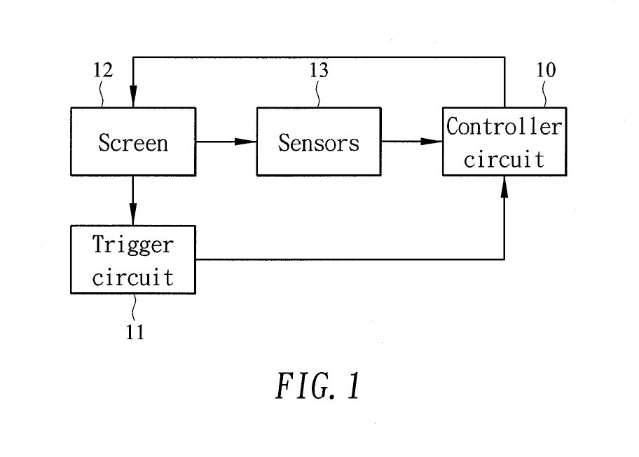

### DETAILED DESCRIPTION OF THE INVENTION

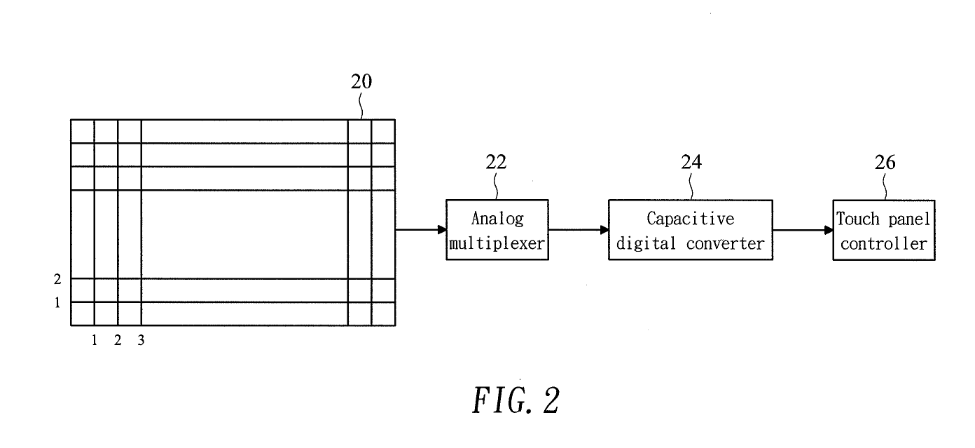

Please refer to FIG. 2 for a touch panel control system, wherein the touch panel control system includes a touch panel 20, an analog multiplexer 22, a capacitive digital converter 24, and a touch panel controller 26. The touch panel controller 26 is configured to receive the sensing results of each sensor on the touch panel 20 through the analog multiplexer 22 and the capacitive digital converter 24. As the technique for obtaining the sensing results of each sensor via the analog multiplexer 22 and the capacitive digital converter 24 is well known in the art, a detailed description of such a technique is omitted herein.

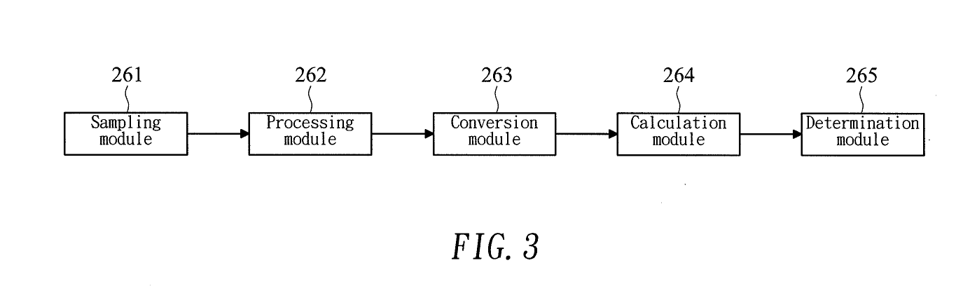

The touch panel controller 26 includes a system according to an embodiment of the present invention for processing the signals of a touch panel. As shown in FIG. 3, the system for processing the signals of a touch panel includes a sampling module 261, a processing module 262, a conversion module 263, a calculation module 264, and a determination module 265. The system for processing the signals of a touch panel is configured to determine whether potential touch point coordinates are the result of finger touch or noise. The following paragraphs describe in detail how each module works to obtain valid sensing results and valid touch point coordinates.

The sampling module 261 is configured to take the sensing results (i.e., capacitive values) of each sensor on the touch panel 20 successively during a period of time, wherein the period of time can be set as appropriate. Once the period of time is set, the sampling module 261 will take the capacitive values of each sensor successively throughout the period of time.

The processing module 262 is configured to calculate the average capacitive value of each sensor for the aforesaid period of time. More specifically, the average capacitive value of each sensor is calculated by removing at least one relatively large value and at least one relatively small value from the plural capacitive values taken by the sampling module 261 and then taking average of the remaining capacitive values. For instance, if the period of time includes four sampling cycles, the sampling module 261 will successively take four capacitive values from each sensor of the touch panel 20. In that case, the processing module 262 can be configured to remove the largest value and the smallest value from the four capacitive values of each sensor and then calculate the average of the remaining two capacitive values of each sensor as the average capacitive value. If the period of time includes eight sampling cycles, the sampling module 261 will take eight capacitive values from each sensor of the touch panel 20 successively, and the processing module 262 can be configured to remove the two largest values and the two smallest values from the eight capacitive values of each sensor and then calculate the average of the remaining four capacitive values of each sensor as the average capacitive value. By removing or deleting at least one relatively large value and at least one relatively small value from the capacitive values of each sensor, the capacitive values which may have been caused by surge noise are filtered out.

The conversion module 263 is configured to read the average capacitive value of each sensor and, by way of calculation, generate at least one set of estimated touch point coordinates. The method for generating estimated touch point coordinates will be detailed further below.

The calculation module 264 is configured to read at least one set of estimated touch point coordinates at each of two sensing time points and calculate the distance between each two sets of estimated touch point coordinates that are read respectively at the two sensing time points. For example, assuming a first set of estimated touch point coordinates (1, 1) are obtained at a first sensing time point, and a second set of estimated touch point coordinates (2, 3) at a second sensing time point, the distance between these two sets of estimated touch point coordinates is calculated as \sqrt{5}.

The determination module 265 is configured to determine whether each of the aforesaid distances is greater than a predetermined distance. If a certain distance is greater than the predetermined distance, the two sets of estimated touch point coordinates corresponding to the distance are defined as invalid touch point coordinates. If a certain distance is less than the predetermined distance, the two sets of estimated touch point coordinates corresponding to the distance are both defined as valid touch point coordinates. Furthermore, if a series of estimated touch point coordinates are successively defined as valid touch point coordinates for a predetermined number of times, the touch point corresponding to each set of valid touch point coordinates in the series is defined as a valid touch point. The predetermined distance can be the distance across three sensors of the touch panel 20, and the predetermined number of times can be four.

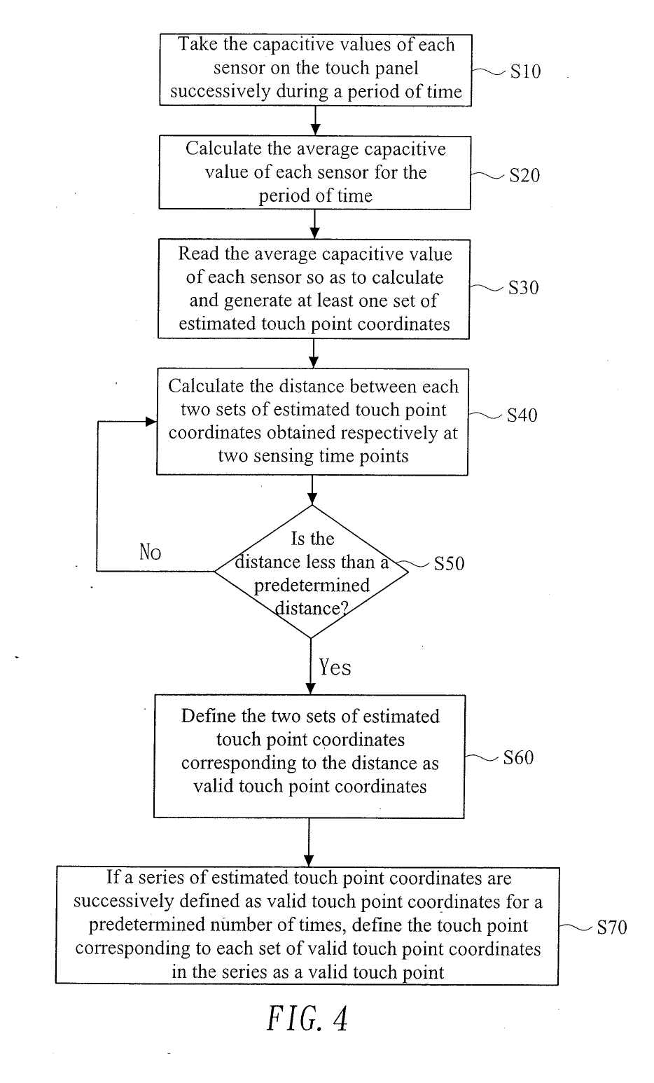

Referring to FIG. 4 in conjunction with FIG. 3, the operation of the foregoing system for processing the signals of a touch panel is described as follows. More particularly, the present embodiment also discloses a method for processing the signals of a touch panel (e.g., the touch panel 20) having a plurality of sensors. The disclosed method includes the steps of: taking the capacitive values of each sensor of the touch panel 20 successively during a period of time (step S10); calculating the average capacitive value of each sensor for the period of time (step S20); reading the average capacitive value of each sensor and, by way of calculation, generating at least one set of estimated touch point coordinates (step S30); calculating the distance between each two sets of estimated touch point coordinates obtained respectively at two sensing time points (step S40); determining whether each distance is less than a predetermined distance (step S50); defining the two sets of estimated touch point coordinates corresponding to the distance as valid touch point coordinates (step S60); and, if a series of estimated touch point coordinates are successively defined as valid touch point coordinates for a predetermined number of times, defining the touch point corresponding to each set of valid touch point coordinates in the series as a valid touch point (step S70). Thus, the touch points obtained through the foregoing steps are valid touch points.

Taking the capacitive values of each sensor of the touch panel 20 successively during a period of time (step S10): The sampling module 261 takes the capacitive values of each sensor on the touch panel 20 successively during a period of time. Whenever the touch panel 20 is activated, or whenever a preset time has elapsed, the sampling module 261 reads the capacitive values sensed by the sensors.

Calculating the average capacitive value of each sensor for the period of time (step S20): After the sampling module 261 successively obtains the capacitive values of each sensor, the processing module 262 calculates the average capacitive value of each sensor for the period of time. The average capacitive value of each sensor is the result of removing at least one relatively large capacitive value and at least one relatively small capacitive value from the capacitive values of each sensor and then taking average of the remaining capacitive values of each sensor.

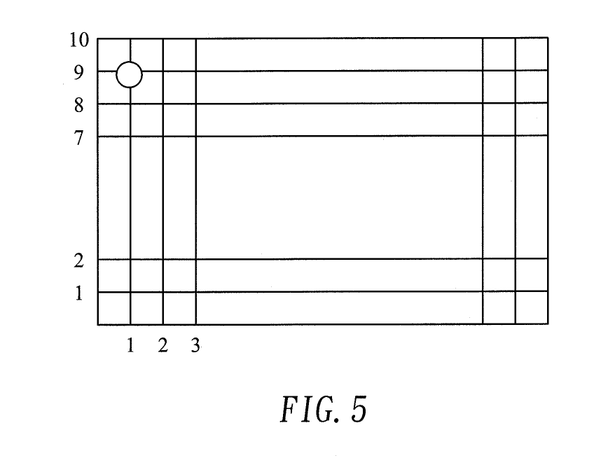

As shown in FIG. 5, the touch panel 20 is provided with a plurality of sensors, and the location of each sensor can be expressed by a set of coordinates. For example, the circle with the coordinates (1, 9) indicates one of the sensors. When the touch panel 20 is touched by a user's finger, the sampling module 261 begins to read the capacitive values of all the sensors on the touch panel 20 for a period of time. In one embodiment, four capacitive values are read from each sensor during that period of time. For instance, capacitive values c1, c2, c3, and c4 are read from the point (1, 9) successively and respectively at time points t1, t2, t3, and t4, wherein c1<c2<c3<c4. The processing module 262 removes the largest capacitive value and the smallest capacitive value and takes average of the remaining two capacitive values to produce the capacitive value of (c2+c3)/2, which is defined as a valid average capacitive value of the sensor at (1, 9).

In another embodiment, eight capacitive values are successively read from each sensor on the touch panel 20 during a period of time. For instance, capacitive values c1, c2, c3, c4, c5, c6, c7, and c8 are read from a sensor successively and respectively at time points t1, t2, t3, t4, t5, t6, t7, and t8, wherein c1<c2<c3<c4<c5<c6<c7<c8. The processing module 262 removes the two largest capacitive values and the two smallest capacitive values and takes average of the remaining four capacitive values to produce the capacitive value of (c3+c4+c5+c6)/4, which is defined as a valid average capacitive value of that particular sensor.

Reading the average capacitive value of each sensor and, by way of calculation, generating at least one set of estimated touch point coordinates (step S30): After the processing module 262 calculates the average capacitive value of each sensor on the touch panel 20, the conversion module 263 reads the average capacitive value of each sensor and then calculates and generates at least one set of estimated touch point coordinates accordingly. In other words, the coordinates of potential touch points are determined based on the previously calculated valid capacitive values.

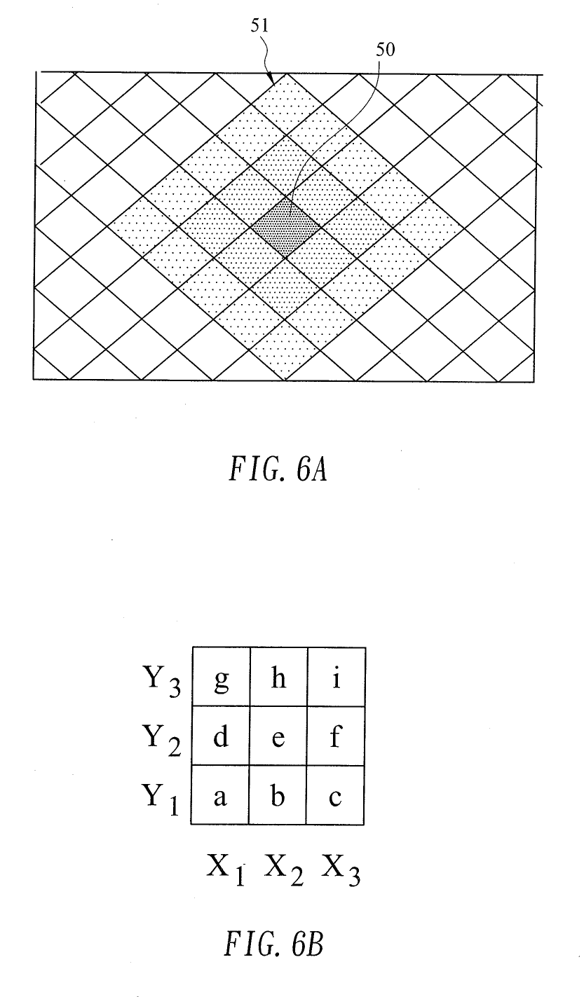

The method for calculating and generating estimated touch point coordinates is described hereinafter by way of example. For each sensor on the touch panel 20, the difference between two successive average capacitive values is calculated and compared with a predetermined threshold value. If a difference is greater than the predetermined threshold value, it is determined that the sensor corresponding to the difference could be a sensor that is actually touched. Among the sensors that are determined as potentially having been touched (i.e., with their respective differences greater than the predetermined threshold value), the sensor whose difference is greater than those of the adjacent such sensors is defined as a touched sensor 50 (as shown in FIG. 6A). The predetermined threshold value can be computed by first calculating the average and the standard deviation of the differences of all the sensors in a region and then adding the average and the standard deviation in a specific proportion, wherein the region may include some or all of the sensors on the touch panel 20.

With reference to FIG. 6A, a comparison region 51 is a 3×3 matrix centered at the touched sensor 50 and includes nine sensors, namely the touched sensor 50 and the eight immediately neighboring sensors (i.e., the sensors immediately above, below, to the left, to the right, to the upper left, to the upper right, to the lower left, and to the lower right of the touched sensor 50). The difference of each sensor in the comparison region 51 is required for comparison. The comparison region 51 can also be enlarged from the 3×3 matrix to a 5×5 matrix. To calculate the difference of each sensor on the touch panel 20, a first average capacitive value and a second average capacitive value of each sensor are successively obtained and stored. Then, a subtraction operation is performed on the first average capacitive value and the second average capacitive value of each sensor to produce the difference of each sensor.

The calculation of estimated touch point coordinates is based on the concept of the center of gravity and essentially involves obtaining all the differences in the comparison region 51 and calculating the location of the center of gravity of these differences, wherein the location of the center of gravity is denoted by a longitudinal coordinate and a transverse coordinate. The longitudinal coordinate is determined by multiplying each difference in the comparison region 51 by the corresponding longitudinal relative position coordinate, adding the products thus obtained, and dividing the sum by the sum of the differences. Similarly, the transverse coordinate is determined by multiplying each difference in the comparison region 51 by the corresponding transverse relative position coordinate, adding the products thus obtained, and dividing the sum by the sum of the differences.

For example, as shown in FIG. 6B, the comparison region 51 is a 3×3 matrix, and the differences of all the sensors in the comparison region 51 are indicated by the letters a to i. In addition, the sensors in this 3×3 matrix have X₁, X₂, and X₃ as their transverse relative position coordinates, and Y₁, Y₂, and Y₃ as their longitudinal relative position coordinates. Therefore, the location (X, Y) of the center of gravity of the comparison region 51 is calculated as:

$$X = \frac{\begin{matrix}a \cdot {X}_{1} + b \cdot {X}_{2} + c \cdot {X}_{3} + d \cdot {X}_{1} + \\ e \cdot {X}_{2} + f \cdot {X}_{3} + g \cdot {X}_{1} + h \cdot {X}_{2} + i \cdot {X}_{3}\end{matrix}}{a + b + c + d + e + f + g + h + i}$$

$$Y = \frac{\begin{matrix}a \cdot {Y}_{1} + b \cdot {Y}_{2} + c \cdot {Y}_{3} + d \cdot {Y}_{1} + \\ e \cdot {Y}_{2} + f \cdot {Y}_{3} + g \cdot {Y}_{1} + h \cdot {Y}_{2} + i \cdot {Y}_{3}\end{matrix}}{a + b + c + d + e + f + g + h + i}$$

Thus, the processing module 262 calculates the difference of each sensor in the comparison region 51, and the location (X, Y) obtained of the gravity center is the location or coordinates of a touch point. However, the method for calculating and generating estimated touch point coordinates is not limited to the above and may be other methods well known in the art for generating estimated touch point coordinates.

Calculating the distance between each two sets of estimated touch point coordinates obtained respectively at two sensing time points (step S40): The calculation module 264 reads, at each of two sensing time points, at least one set of estimated touch point coordinates generated by the conversion module 263. Afterward, the calculation module 264 calculates the distance between each two sets of estimated touch point coordinates read respectively at the two sensing time points.

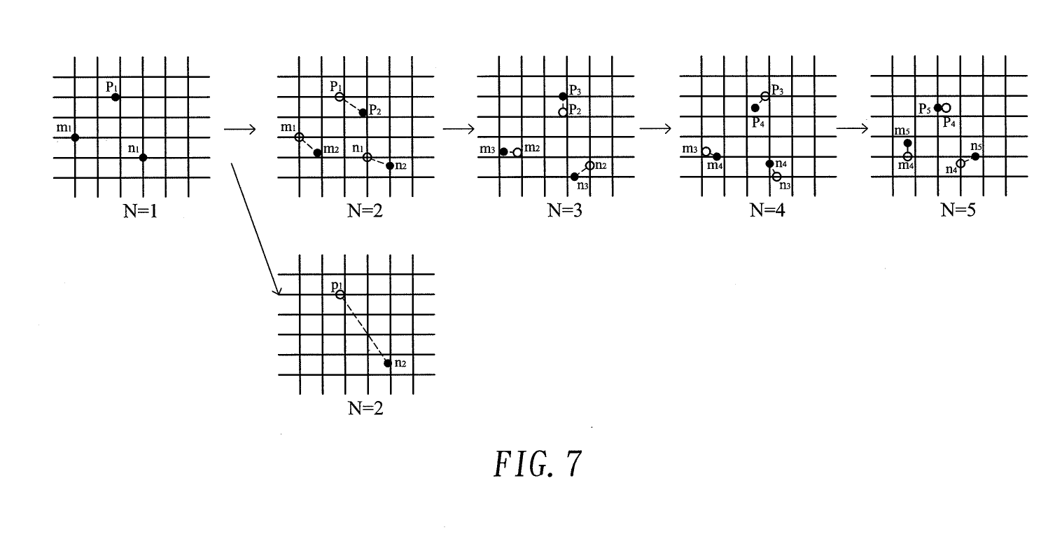

For example, referring to FIG. 7, the conversion module 263 generates three potential touch points p1, m1, and n1 (and hence three sets of estimated touch point coordinates) at a first sensing time point (N=1) and three potential touch points p2, m2, and n2 (and hence another three sets of estimated touch point coordinates) at a second sensing time point (N=2). By the same token, p3, m3, and n3; p4, m4, and n4; and p5, m5, and n5 (and their coordinates) are the potential touch points (and estimated touch point coordinates) generated by the conversion module 263 at a third sensing time point (N=3), a fourth sensing time point (N=4), and a fifth sensing time point (N=5) respectively.

The calculation module 264 is configured to calculate the distance between each two sets of estimated touch point coordinates read respectively at two sensing time points. For instance, the calculation module 264 calculates the linear distance between the points p1 and p2, the linear distance between the points p1 and m2, the linear distance between the points p1 and n2, the linear distance between the points m1 and p2, the linear distance between the points m1 and m2, the linear distance between the points m1 and n2, the linear distance between the points n1 and p2, the linear distance between the points n1 and m2, and the linear distance between the points n1 and n2, wherein the former and the latter points in each of the aforementioned pairs are generated at the first sensing time point (N=1) and the second sensing time point (N=2) respectively. In the drawing corresponding to the second sensing time point (N=2), the hollow circle p1 represents the estimated touch point coordinates generated at the first sensing time point (N=1), the solid circle p2 represents the estimated touch point coordinates generated at the second sensing time point (N=2), and the rest can be deduced by analogy.

Determining whether each distance is less than a predetermined distance (step S50): Based on the distances generated by the calculation module 264, the determination module 265 determines whether the distance between each two sets of estimated touch point coordinates read respectively at two sensing time points is less than a predetermined distance. The predetermined distance can be set at the distance across three sensors, for a single finger generally cannot move beyond this distance between two consecutive sensing time points. It should be noted that the value of the predetermined distance will affect end results. If the predetermined distance is set shorter, say the distance across two sensors, the precision of touch point determination will increase due to enhanced noise reduction, but a fast finger movement along the touch panel 20 whose moving distance exceeds the predetermined distance will be regarded as noise and filtered out.

Defining the two sets of estimated touch point coordinates corresponding to the distance as valid touch point coordinates (step S60): If the determination module 265 determines that the distance between any two sets of estimated touch point coordinates generated by the conversion module 263 is less than the predetermined distance, the two sets of estimated touch point coordinates corresponding to the distance will be defined by the determination module 265 as valid touch point coordinates.

For instance, if the distance between the potential touch point n2 generated at the second sensing time point and the potential touch point n1 generated at the first sensing time point is determined by the determination module 265 as less than the predetermined distance (e.g., the distance across three sensors), meaning that it is possible for the potential touch point n1 to move to the potential touch point n2 during the interval between the first and the second sensing time points, the movement between the potential touch points n1 and n2 will be defined as valid movement, and the coordinates of both potential touch points n1 and n2 will be defined as valid touch point coordinates. In addition, the potential touch points n1 and n2 will be kept as candidate touch points for subsequent calculation.

On the contrary, if the distance between the potential touch point n2 generated at the second sensing time point and the potential touch point p1 generated at the first sensing time point is determined by the determination module 265 as greater than the distance across three sensors, meaning that it is physically impossible for the potential touch point p1 to move to the potential touch point n2 during the interval between the first and the second sensing time points. The movements involving the potential touch points p1 and n2 will be regarded as the results of noise and be filtered out.

If a series of estimated touch point coordinates are successively defined as valid touch point coordinates for a predetermined number of times, defining the touch point corresponding to each set of valid touch point coordinates in the series as a valid touch point (step S70): Once the candidate touch points are determined by the determination module 265 using the distance-based criterion, it is further determined by the determination module 265 whether the candidate touch points are valid touch points, based on the number of times for which the corresponding estimated touch point coordinates are successively detected. For example, if the number of times for which a certain series of estimated touch point coordinates successively show up is greater than or equal to a predetermined number of times (e.g., four), then each touch point in the series will be defined as a valid touch point. More particularly, as the series of estimated touch point coordinates are all valid touch point coordinates, the touch point corresponding to each set of valid touch point coordinates in the series is defined by the determination module 265 as a valid touch point.

In the foregoing embodiment, a valid touch is defined by the determination module 265 by being detected at least four successive sensing time points (e.g., N1, N2, N3, N4, and N5). Therefore, after the valid touch point coordinates (e.g., of p1, m1, and n1) are determined using the distance-based criterion, the number of times for which the valid touch point coordinates are successively detected is used as the criterion for determining valid touch points. If a touch point shows up at four or more than four sensing time points in a row, the touch point will be defined as a valid touch point; otherwise, the touch point will be filtered out as the result of noise. In FIG. 7 for example, p1, p2, p3, p4, and p5 are a series of valid touch points, and n1, n2, n3, n4, and n5 are another series of valid touch points.

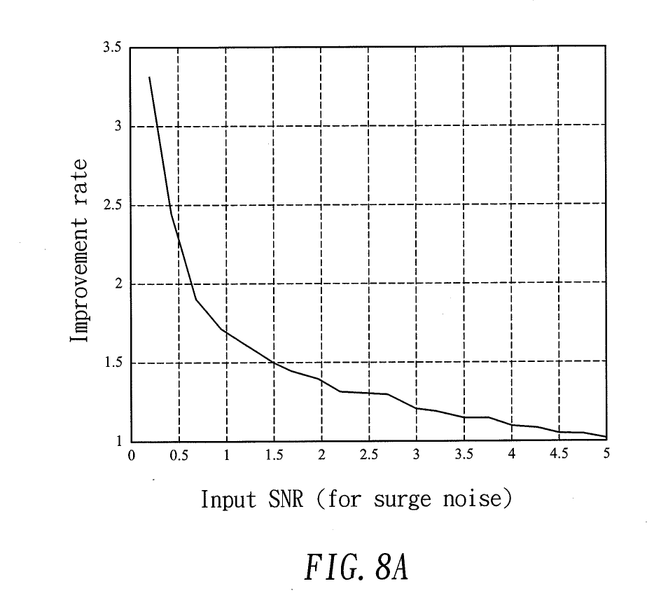

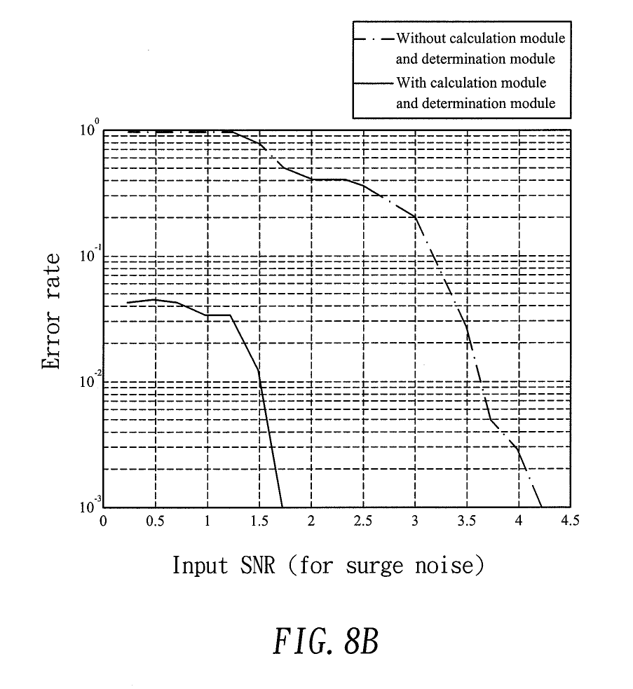

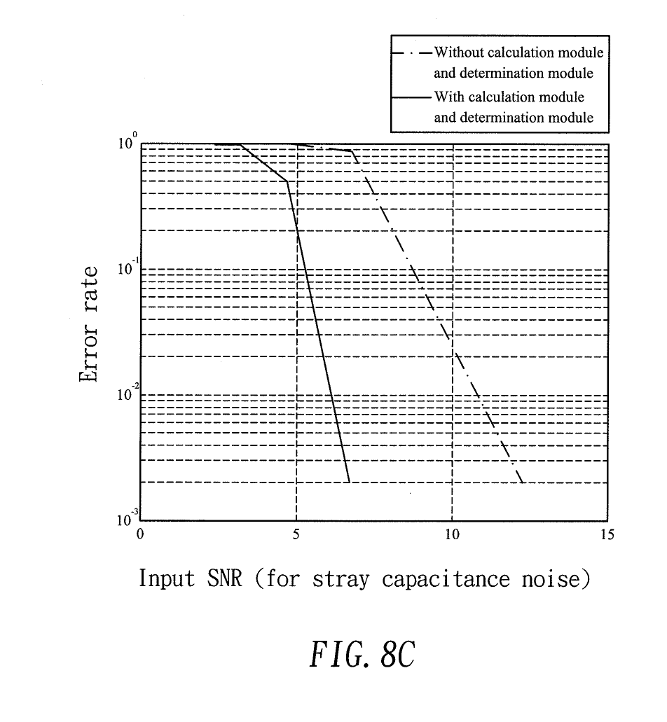

The improvement rate and performance after using the sampling module 261 and the processing module 262 are shown in FIG. 8A, wherein the transverse axis represents input signal-to-noise ratio (SNR) for surge noise, and the longitudinal axis represents improvement rate. As can be seen in the drawing, when the sampling module 261 and the processing module 262 are used, the improvement rate is significant at low input SNR. For example, when the input SNR is below 1.5, the sampling module 261 and the processing module 262 increase the signal-to-noise ratio by at least 1.5 times; when the input SNR falls below 0.6, the sampling module 261 and the processing module 262 increase the signal-to-noise ratio at least twofold. In this embodiment, “performance” is expressed by signal-to-noise ratio, “signal” refers to capacitive values resulting from finger touch, and “noise” refers to capacitive values measured at non-touch points, or points that are not actually touched. Furthermore, the input SNR in this embodiment is adjusted to the desired levels by varying the magnitude of surge noise while fixing the capacitive value caused by finger touch. As used herein, “surge noise” refers to the maximum value of noise, and the probability of having surge noise in any of four over-sampled sensing results is ¼.

In FIG. 8B, the transverse axis represents input SNR for surge noise, and the longitudinal axis represents error rate. In this embodiment, the desired input SNR is also reached by varying the magnitude of surge noise while fixing the capacitive value caused by finger touch. As shown in the drawing, the error rate is reduced to 1% at an input SNR of 3.6 in the absence of the calculation module 264 and the determination module 265 (as indicated by the dashed line); however, the same performance is achieved at an input SNR as low as 1.5 when the calculation module 264 and the determination module 265 are used (as indicated by the solid line). In this embodiment, “performance” is expressed by error rate, and “error rate” is defined as the probability of having both real touch points and noise-caused false touch points in the detected touch points, in a thousand measurements.

In FIG. 8C, the transverse axis represents input SNR for stray capacitance noise, and the longitudinal axis represents error rate. In this embodiment, the desired input SNR is reached by varying the magnitude of stray capacitance noise while fixing the capacitive value caused by finger touch. Herein, the magnitude of capacitance refers to the square root of the average power of all the noises at non-touch points. As shown in FIG. 8C, when the calculation module 264 and the determination module 265 are absent (as indicated by the dashed line), the input SNR required to bring the error rate down to 1% is 11. However, when the calculation module 264 and the determination module 265 are employed (as indicated by the solid line), the same performance is achieved at an input SNR as low as 7. This embodiment demonstrates that the calculation module 264 and the determination module 265 are conducive to better performance.

The embodiments described above serve to demonstrate the features of the present invention so that a person skilled in the art can understand the contents disclosed herein and implement the present invention accordingly. The embodiments, however, are not intended to limit the scope of the present invention, which is defined only by the appended claims. Therefore, all equivalent changes or modifications which do not depart from the spirit of the present invention should fall within the scope of the appended claims.

What is claimed is:

1. A method for processing signals of a touch panel, wherein the touch panel comprises a plurality of sensors, the method comprising the steps of:
(a) taking capacitive values of each said sensor of the touch panel successively during a period of time;
(b) calculating an average capacitive value of each said sensor for the period of time, wherein, for each said sensor, the average capacitive value is calculated by removing at least one relatively large said capacitive value and at least one relatively small said capacitive value from the capacitive values taken and then taking average of remaining said capacitive values;
(c) reading the average capacitive value of each said sensor so as to calculate and generate at least one set of estimated touch point coordinates;
(d) repeating the steps (a) to (c) so as to obtain at least one set of said estimated touch point coordinates at each of two consecutive sensing time points, and calculating a distance between each two sets of said estimated touch point coordinates obtained respectively at the two sensing time points;
(e) determining whether each said distance is less than a predetermined distance, wherein if one said distance is greater than the predetermined distance, the two sets of estimated touch point coordinates corresponding to the distance are defined as invalid touch point coordinates; wherein if one said distance is less than the predetermined distance, the two sets of estimated touch point coordinates corresponding to the distance are defined as valid touch point coordinates; and
(f) repeating the step (e), and if a series of said estimated touch point coordinates are defined as said valid touch point coordinates successively for a predetermined number of times, defining a touch point corresponding to each set of said valid touch point coordinates in the series as a valid touch point.

2. The method of claim 1, wherein the period of time in the step (a) includes four sampling cycles such that four said capacitive values are successively taken of each said sensor of the touch panel, and wherein the step (b) comprises removing one relatively large said capacitive value and one relatively small said capacitive value from the four capacitive values of each said sensor and then taking average of the remaining two capacitive values of each said sensor so as to produce the average capacitive value of each said sensor.

3. The method of claim 1, wherein the period of time in the step (a) includes eight sampling cycles such that eight said capacitive values are successively taken of each said sensor of the touch panel, and wherein the step (b) comprises removing two relatively large said capacitive values and two relatively small said capacitive values from the eight capacitive values of each said sensor and then taking average of the remaining four capacitive values of each said sensor so as to produce the average capacitive value of each said sensor.

4. The method of claim 1, wherein the predetermined distance is a distance across three said sensors of the touch panel.

5. The method of claim 1, wherein the predetermined number of times is four.

6. A system for processing signals of a touch panel, wherein the touch panel comprises a plurality of sensors, the system comprising:
a sampling module for taking capacitive values of each said sensor of the touch panel successively during a period of time;
a processing module for calculating an average capacitive value of each said sensor for the period of time, wherein, for each said sensor, the average capacitive value is calculated by removing at least one relatively large said capacitive value and at least one relatively small said capacitive value from the capacitive values taken and then taking average of remaining said capacitive values;
a conversion module for reading the average capacitive value of each said sensor and, by calculation, generating at least one set of estimated touch point coordinates;
a calculation module for reading at least one set of said estimated touch point coordinates at each of two sensing time points and calculating a distance between each two sets of said estimated touch point coordinates read respectively at the two sensing time points; and
a determination module for determining whether each said distance is greater than a predetermined distance, wherein if one said distance is greater than the predetermined distance, the two sets of estimated touch point coordinates corresponding to the distance are defined as invalid touch point coordinates; if one said distance is less than the predetermined distance, the two sets of estimated touch point coordinates corresponding to the distance are defined as valid touch point coordinates; and if a series of said estimated touch point coordinates are defined as said valid touch point coordinates successively for a predetermined number of times, a touch point corresponding to each set of said valid touch point coordinates in the series is defined as a valid touch point.

7. The system of claim 6, wherein the period of time includes four sampling cycles such that four said capacitive values are successively taken of each said sensor of the touch panel, and wherein the average capacitive value of each said sensor is calculated by removing one relatively large said capacitive value and one relatively small said capacitive value from the four capacitive values of each said sensor and then taking average of the remaining two capacitive values of each said sensor.

8. The system of claim 6, wherein the period of time includes eight sampling cycles such that eight said capacitive values are successively taken of each said sensor of the touch panel, and wherein the average capacitive value of each said sensor is calculated by removing two relatively large said capacitive values and two relatively small said capacitive values from the eight capacitive values of each said sensor and then taking average of the remaining four capacitive values of each said sensor.

9. The system of claim 6, wherein the predetermined distance is a distance across three said sensors of the touch panel.

10. The system of claim 6, wherein the predetermined number of times is four.
